(19) United States
(12) Patent Application Publication
(10) Pub. No.: US 2026/0039356 A1
(43) Pub. Date: Feb. 5, 2026

(54) METHODS, APPARATUSES AND SYSTEM FOR PREVENTING RADIO LINK FAILURE DUE TO BLOCKAGES

(71) Applicant: Nokia Technologies Oy, Espoo (FI)

(72) Inventors: Mark DOLL, Stuttgart (DE); Silvio MANDELLI, Tamm (DE); Maximilian ARNOLD, Murrhardt (DE)

(21) Appl. No.: 18/998,168

(22) PCT Filed: Aug. 1, 2022
(86) PCT No.: PCT/EP2022/071593

§ 371 Date: Jan. 24, 2025

(51) Int. Cl. H04B 7/06

(52) U.S. Cl. CPC H04B 7/063

(57) ABSTRACT

Inter-alia, a method is disclosed including receiving a communication report indicative of information relating to at least one radio link between a base station of the mobile communication network and a user device, wherein at least a part of the communication report is indicative of an angle-of-arrival of the respective radio link and an angle-of-departure of the respective radio link; determining a blockage information based, at least in part, on the communication report, and a position of the base station and a position of the user device, wherein the blockage information is indicative of the respective radio link and a time when a blockage of the respective radio link occurs; and providing, if a blockage information is determined, the blockage information. It is further disclosed an according apparatus, computer program and system.

### FIELD

The following disclosure relates to the field of mobile communication networks, or more particularly, to preventing of radio link failures due to blockages in radio links.

### BACKGROUND

Next generation (6G) mobile communication is envisioned to extend current 5G networks, which is only able to localize active, i.e. transmitting/receiving, devices, to a joint physical-biological network, where the mobile network is capable of sensing the state and behavior of passive objects within its environment.

Already 5G introduced so-called frequency range 2 (FR2), which has higher carrier frequencies with the 28 GHz mmWaveband as one its first FR2 frequency bands. 6G is expected to further extend to even higher frequencies in the THz range (>300 GHZ). While higher frequency bands enable much larger communication bandwidths and thereby much higher throughputs, they become increasingly prone to blockage as diffraction (“bending” of radio signal around object corners) decreases and attenuation by objects increases. Transmission reception points (TRP) e.g. provided by a respective base station and mobiles (e.g. UEs) therefore direct signal energy through beamforming, leading to the so-called beam-based air interface.

The narrow transmission (Tx) and reception (Rx) beam of typically only few degrees half power beam width (HPBW) require permanent beam adaptation/refinement to maintain a working communication link between UE and its serving TRP (e.g. base station), as the signal strength may quickly degrade outside the beam's main lobe. More critically, rotation of the object/machinery a UE is attached to (or the human holding it) may lead to this object (human) blocking the communication path between a respective UE and its serving cell/TRP, leading to additional strong attenuation of the signal. Equally, other (passive) objects may block the communication link when moving into the communication path, or vice versa if the UE itself moves behind such (possibly static) objects.

Currently, a beam pair, e.g. the pair of Tx beam and Rx beam at a respective base station and a respective UE, respectively (downlink, or vice versa for uplink), is switched if periodic channel measurements have identified that another beam pair will be (e.g. sufficiently) better than the current beam pair. This kind of reactive beam management works well as long as the link mostly degrades due to misalignment (pointing into a slightly off direction) of beams, e.g. but may fail if signal quality degrades very fast due to blockage(s) such that it causes a radio link failure (RLF) before the beam could be switched.

One envisioned use case of sensing in 6G is therefore to locate passive objects and extrapolate their movement into the near future to predict if they may block any ongoing communication link and to proactively switch beams before the link fails.

When targeting Ultra Reliable Low Latency Communications (URLLC) in wireless networks (e.g. a mobile communication network) e.g. in FR2 bands, interruption of communication due to sudden obstructions by (large) objects may be mitigated. One solution may be to use dual/multi-connectivity and rely on a fully-maintained secondary link to fall back to during blockage/failure of the primary link until beam search/refinement/update procedures reestablished the primary link. The second link could be a lower frequency carrier in FR1 from the same TRP or another FR2 carrier from a second

TRP. Another subject may be to proactively switch beams or handover to another TRP before the obstruction/blockage occurs or may occur.

### SUMMARY OF SOME EXEMPLARY EMBODIMENTS

However, in such proactively switching of beams, and in future sensing-capable 6G mobile networks, it is assumed that a central entity, in the following called sensing management function (SMF) may collect all sensing information and derives thereof a digital twin of the environment the mobile network is located in. What sensing does not provide, though, are the communication paths between TRPs and UEs in the mobile communication network.

According to a first exemplary aspect, a method is disclosed, the method comprising:
receiving a communication report indicative of information relating to at least one radio link between a base station of the mobile communication network and a user device, wherein at least a part of the communication report is indicative of an angle-of-arrival of the respective radio link and an angle-of-departure of the respective radio link;
determining a blockage information based, at least in part, on the communication report, and a position of the base station and a position of the user device, wherein the blockage information is indicative of the respective radio link and a time when a blockage of the respective radio link occurs; and
providing, if the blockage information is determined, the blockage information.

This method may for instance be performed and/or controlled by an apparatus, for instance a central entity, or a server hosting a function (e.g. the central entity) of a mobile communication network. Such a function may be the SMF. Alternatively, this method may be performed and/or controlled by more than one apparatus, for instance a server cloud comprising at least two servers. For instance, the method may be performed and/or controlled by using at least one processor of the central entity or the server.

According to a second exemplary aspect, a method is disclosed, the method comprising:
transmitting a communication report indicative of information relating to at least one radio link between the apparatus and a user device, wherein at least a part of the communication report is indicative of at least one of an angle-of-arrival of the respective radio link or an angle-of-departure of the respective radio link;
receiving a blockage information indicative of the respective radio link and a time when a blockage of the respective radio link occurs, or
   in case a blockage information is not received,
determining a blockage information based, at least in part, on the communication report and a position of the base station and a position of the user device, wherein the blockage information is indicative of the respective radio link and a time when a blockage of the respective radio link occurs; and
determining at least one measure based, at least in part, on the received blockage information or the determined blockage information to mitigate the blockage of the respective radio link; and
applying the determined at least one measure.

This method may for instance be performed and/or controlled by an apparatus, for instance a base station, such as a gNB or eNB of a mobile communication network, or a base station providing or hosting at least one TRP. For instance, the method may be performed and/or controlled by using at least one processor of the base station.

According to a third exemplary aspect, a method is disclosed, the method comprising:
transmitting a communication report indicative of information relating to at least one radio link between the apparatus and a base station of the mobile communication network, wherein at least a part of the communication report is indicative of at least one of an angle-of-arrival of the respective radio link or an angle-of-departure of the respective radio link; and
applying at least one measure to mitigate a blockage of the respective radio link.

This method may for instance be performed and/or controlled by an apparatus, for instance a user equipment or user device of a mobile communication network. For instance, the method may be performed and/or controlled by using at least one processor of the user equipment or user device.

According to a further exemplary aspect, a computer program is disclosed, the computer program when executed by a processor causing an apparatus, for instance a server, to perform and/or control the actions of the method according to the first, second and/or third exemplary aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary aspect, an apparatus is disclosed, configured to perform and/or control or comprising respective means for performing and/or controlling the method according to the first, second and/or third exemplary aspect.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

According to a further exemplary aspect, an apparatus is disclosed, comprising at least one processor and at least one memory including computer program code, the at least one memory and the computer program code configured to, with the at least one processor, cause an apparatus, for instance the apparatus, at least to perform and/or to control the method according to the first, second and/or third exemplary aspect.

The above-disclosed apparatus according to any aspect may be a module or a component for a device, for example a chip. Alternatively, the disclosed apparatus according to any aspect may be a device, for instance a server or server cloud. The disclosed apparatus according to any aspect may comprise only the disclosed components, for instance means, processor, memory, or may further comprise one or more additional components.

According to a further exemplary aspect, a system is disclosed, comprising:
a first apparatus according to the first exemplary aspect as disclosed above and a second apparatus according to the second exemplary aspect as disclosed above; and
at least one apparatus according to the third exemplary aspect as disclosed above.

According to a further exemplary aspect, a system is disclosed, comprising:
a second apparatus according to the second exemplary aspect as disclosed above; and
at least one apparatus according to the third exemplary aspect as disclosed above.

Any disclosure herein relating to any exemplary aspect is to be understood to be equally disclosed with respect to any subject-matter according to the respective exemplary aspect, e.g. relating to an apparatus, a method, a computer program, and a computer-readable medium. Thus, for instance, the disclosure of a method step shall also be considered as a disclosure of means for performing and/or configured to perform the respective method step. Likewise, the disclosure of means for performing and/or configured to perform a method step shall also be considered as a disclosure of the method step 15 itself. The same holds for any passage describing at least one processor; and at least one memory including computer program code; the at least one memory and the computer program code configured to, with the at least one processor, cause an apparatus at least to perform a step.

For convenience, a list of abbreviations used in the following is already given at this point:
5G 5th Generation
5GS 5G System
6G 6th Generation

AMF Access and Mobility Management Function
AoA Angle of Arrival
AoD Angle of Departure
BSAI Beam Selection Assistance Information
eNB eNodeB (base station)
FR1 Frequency Range 1 (cm-wave, <7.125 GHz)
FR2 Frequency Range 2 (mm-wave, >24 GHz)
gNB gNodeB (base station)
HPBW Half Power Beam Width
LMF Location Management Function
LOS Line of Sight
MAC Medium Access Control
NAS Non-Access Stratum
NCGI NR Cell Global Identity
NG-RAN Next Generation RAN
nLoS non Line of Sight
NR New Radio
NRPPa NR Positioning Protocol a
PHY Physical Layer
RAN Radio Access Network
RLF Radio Link Failure
RRC Radio Resource Control
Rx Receiver/Reception
SAP Sensing Access Point
SMF Sensing Management Function
SRB Signaling Radio Bearer
TDOA Time Difference of Arrival
TRP Transmission (and) Reception Point
Tx Transmitter/Transmission
UE User Equipment (mobile device, also referred to as user device)

In the following, exemplary features and exemplary embodiments of all aspects will be described in further detail.

The UE or user device according to the third exemplary aspect as described above will also be referred to as the apparatus according to the third exemplary aspect in the following. It may be a user device of a mobile communication network (also referred to as cellular network), for instance a 3G, LTE/4G, 5G NR, 5G or 6G network. Further, it may be a mobile or transportable device, e.g. a handset, a smartphone, a tablet, a laptop, or any other mobile device. In various embodiments, it may be a vehicle for travelling in air, water, or on land, e.g. a plane or a drone, a ship or a car or a truck. It may also be a robot, a sensor device, a wearable device, an Internet of Things (IoT) device, a Machine Type Communication (TC) device, or the likes.

A respective radio link, as used herein, may be understood as means for a (e.g. wireless) communication between a first entity and a second entity (e.g. the apparatus of the first and/or second exemplary aspect, and the apparatus of the third exemplary aspect). The communication may be a uni-or bidirectional communication. The communication may be established via the mobile communication network, or directly between the respective entities, so-called ad-hoc communication. The radio link may be established via one or more antenna elements or antenna arrays comprised by or connectable to a respective entity. The respective radio link may be a certain beam emittable (e.g. and thus receivable) via the one or more antenna elements or antenna panels. The respective radio link may be represented by at least one beam pair, e.g. one beam representing the Tx side of the communication between the entities, and one beam representing the Rx side of the communication between the entities. The respective radio link may be identifiable by a respective identifier, ID.

Such a respective radio link may be subject to a blockage. Such a blockage, as used herein, may be elicited by a physical barrier, such as an object (e.g. a wall, building, car, tree, or the like) that is in between a radio link causing that respective radio waves of the radio link cannot take a direct path since the object attenuates or shields the radio waves so that the radio waves cannot pass, at least in part, through the object. Such an object may be a machinery a respective user device is attached to, or may be the user (human) holding the user device.

The communication report is indicative of information relating to at least one radio link between a base station (e.g. apparatus of the second exemplary aspect) of the mobile communication network and a user device (e.g. apparatus of the third exemplary aspect). The communication report is received by the apparatus of the first exemplary aspect. The apparatus of the first exemplary aspect may be function of the mobile communication network, e.g. a SMF. Such a SMF may be a function of a core network of the mobile communication network, which may optionally be hosted by a central entity. One or more user devices (e.g. apparatus(es) of the third exemplary aspect) and one or more base stations (e.g. apparatus(es) of the second exemplary aspect) may communicate with each other and/or such a SMF, e.g. for communicating e.g. sensing measurements or sensing measurement reports. Such a SMF may not be a Session Management Function of the overall 5GS architecture (e.g. as disclosed in 3GPP TS 23.501), but an additional function that may communicate with a respective AMF and/or LMF of the mobile communication network (e.g. according to 5GS communication standard). Whether the apparatus of the first exemplary aspect (e.g. SMF) may be a separate entity e.g. with own interface(s) to a respective LMF and/or AMF, or whether the apparatus of the first exemplary aspect (e.g. SMF) may be integrated at the LMF can be left open. Both implementation variants are considered to work equally well e.g. since (e.g. only) the used application layer protocol for transmitting (e.g. carrying) related messages may differ. Such a respective SMF may comprise means for or be enabled for learning about communication links within the mobile communication network, and/or comprise means for or be enabled for informing a respective mobile communication network about a (e.g. likely) blockage of one of the respective communication radio links. The communication report may be or be comprised by a respective signalling message.

At least a part of the communication report is indicative of an angle-of-arrival (AoA) of the respective radio link and an angle-of-departure (AoD) of the respective radio link. For instance, as a signaling framework, uplink control information (UCI) in case of PHY and/or MAC control elements (CE) in case of MAC layer signaling may be used for the communication. Further, respective radio resource control (RRC) information elements transmittable via RRC signaling may be defined such that the apparatus of the second exemplary aspect (e.g. base station, such as a gNB) can configure the apparatus of the third exemplary aspect (e.g. user device) to provide (e.g. report) the AoA and/or AoD (e.g. in the form of a respective communication report).

The blockage information is determined based, at least in part, on the communication report, and a position of the base station and a position of the user device. The respective position of the base station (e.g. apparatus of the second exemplary aspect) and/or the respective position of the user device (e.g. apparatus of the third exemplary aspect) may be determined, or gathered (e.g. derived, for instance via a look-up query at the LMF). The blockage information is indicative of the respective radio link. For instance, the blockage information may be indicative of the respective radio link in case the respective radio link is subject to a blockage, or subject to a likely blockage. For this, the blockage information may represent a certain likelihood that may be predicted in conjunction with the determining of the blockage information.

Further, the blockage information is indicative of a time when a blockage of the respective radio link occurs. Again, the time may represent a time that is predicted, e.g. by the apparatus of the first exemplary aspect. The time may be determined (e.g. predicted) in conjunction with the determining of the blockage information. Both the respective radio link and the time as comprised by the blockage information may represent a present blockage, or may represent that a blockage of the respective radio link is likely (to occur) in the future. The latter may be determined or assessed based on a pre-determined threshold value, to name but one non-limiting example, to determine whether the blockage is considered likely or not.

After the blockage information has been determined, the blockage information may be provided (e.g. sent), e.g. to a base station (e.g. apparatus of the second exemplary aspect) and/or a user device (e.g. apparatus of the third exemplary aspect). For instance, a respective base station (e.g. apparatus of the second exemplary aspect) may then determine (e.g. decide) if and/or how to mitigate the potential blockage that is occurring or that may occur to the respective radio link, e.g. by determining a respective measure. More details on this are disclosed below. In addition or in the alternative, ad-hoc communication report procedure(s) may be defined. Such an ad-hoc communication procedure may be performed and/or controlled by providing (and thus receiving) the communication report directly e.g. from the apparatus of the second exemplary aspect (e.g. base station) and/or directly from the apparatus of the third exemplary aspect (e.g. user device). Thus, not via the mobile communication network. Further, signalling from a respective base station (e.g. gNB) and a respective user device (e.g. via a base station) to a respective SMF (e.g. apparatus of the first exemplary aspect) may be enabled.

Further, ad-hoc notification message(s) from such a respective SMF to such a respective base station (e.g. gNB) may be defined or enabled.

The blockage information may further comprise e.g. a value indicative of how strong a respective blockage will be or is expected to be. The value may be an integer value between 0 and 1, wherein 0 may be no blockage, and 1 may be the blockage is blocking the entire radio link. For instance, a value of 1 may mean that the respective radio link is subject to full attenuation, e.g. the received signal power is then 0 behind the blockage. In addition or in the alternative, the value may be given as an estimated additional attenuation e.g. caused by the blockage/blocker (e.g. in dB, e.g. 30 dB for a 1000-fold weakening of the signal, to name but one non-limiting example).

Example embodiments of all exemplary aspects may allow that a respective apparatus of the first exemplary aspect (e.g. a respective SMF) supports beam recovery and is enabled to prevent one or more radio link failures (RLFs), e.g. by providing a respective blockage information.

For instance, beam recovery may be done by a base station. Example embodiments of all exemplary aspect may target 5G NR TRPs in FR2 with high antenna element count (e.g. antenna panels with 64 and more antenna elements), and accordingly tight communication beams (e.g. beam pattern(s)), with FR2—typical large carrier bandwidths needed for one or more of the example embodiments. Further, (e.g. only) these tight communication beams used in FR2 may be prone to the problem of severe blockage and following RLF in the first place. For these circumstances, the example embodiments may be utilized and may represent one example of an applicable scenario.

According to an exemplary embodiment of the first exemplary aspect, the determining of the blockage information further comprises:
determining whether the respective radio link is subject to a blockage or not.

The determining whether the respective radio link is subject to a blockage or not may be performed and/or controlled based, at least in part, on a determining if the respective radio link is a LoS, or nLoS radio link. In the latter case, the determining whether the respective radio link is subject to a blockage or not may in addition require to determine how many reflections occur during the communication path, thus, how many times the radio signal is reflecting on its communication path from a sender to a receiver.

Such communication path(s) may either be LoS or nLos. In the latter case, the radio signal may be reflected via a single (e.g. cluster of) reflector(s) respectively reflection(s). Such reflections may be characterized by respective positions of the respective apparatus of the third exemplary aspect (e.g. a user device) and a respective TRP (e.g. enabled or provided by a respective apparatus of the second exemplary aspect) and their respective AoA and AoD of the radio link as seen from the perspective of a TRP and/or the respective user device. LoS communication path may also have reflection(s) of the radio signal, however, at least a part of the radio signal is receivable without having been subject to any reflection, contrary to nLoS communication path(s). For instance, such nLoS communication path(s) with two or more reflections may additionally require that the respective locations of the two (e.g. clusters of) reflectors may be determined. The respective locations may be determined e.g. by a sensing procedure. For instance, such a sensing procedure may include the SMF determining a plurality of SAPs to enable a scan of an area; requesting a first SAP to receive a probing signal transmitted by a second

SAP configured by the SMF to transmit a probing signal; the first SAP after receiving the probing signal, sending the scan measurement back to the SMF to provide information about the area; and the SMF aggregating the scan measurement with other scan measurements from the other SAPs, creating a digital twin of the sensed area. Such communication path(s) with three or more reflections may generally be too weak to contribute significant energy, and may therefore be disregarded. However, it will be understood that as long as enough energy may be present at the receiver side of the respective radio link, the number of reflections may not be of further interest.

AoA and AoD are provided (e.g. reported) by the apparatus of the third exemplary aspect (e.g. a user device) and/or the apparatus of the second exemplary aspect (e.g. a respective base station, such as a gNB providing a respective TRP) to the apparatus of the first exemplary aspect via the proposed communication report.

AoA and AoD may either be indicated in the respective communication report with respect to a global coordinate system (e.g. known to all entities) or in a relative manner, e.g. in relation to respective one or more antenna elements or antenna panels of the apparatus of the second and/or third exemplary aspect, respectively. For the relative manner, a respective antenna orientation may be needed to be known e.g. by the respective SMF. AoA and AoD of a respective radio link may be indicated as a beam index, e.g. provided the one or more antenna elements or antenna panels orientation and possibly beam codebook are known to the apparatus of the first exemplary aspect (e.g. SMF). If such a beam codebook may not be known by the apparatus of the first exemplary aspect, the respective beam codebook may be learned from the apparatus(es) of the third exemplary aspect (e.g. user device(s)) and/or apparatus(es) of the second exemplary aspect (e.g. gNB(s) respectively TRP(s), e.g. acting as SAP(s) via the TRP Information request/response message(s)), to name but a few non-limiting examples. The respective communication report (e.g. in the form of (a) message(s) or comprised by such (a) message(s)) may optionally include or comprise one or more locations of the respective apparatus(es) as determined by localization. Regularly, such positions may be known to the apparatus of the first exemplary aspect (e.g. SMF), e.g. from the respective LMF of the mobile communication network, or since both may be integrated together in a single entity. The respective identity of the apparatus of the third exemplary aspect (e.g. a respective user device) and/or of the apparatus of the second exemplary aspect (e.g. a respective TRP/base station) may be provided by the transport respectively application layer protocol for interfaces N1/N2/NL1. At least one of such a respective interfaces may be used to provide (e.g. deliver/sent) the respective communication report such that the apparatus of the first exemplary aspect (e.g. SMF) may infer where the communication report (e.g. message) originated from. This may further allow to determine (e.g. derive) to which TRP and user device AoA and/or AoD and optionally locations/positions of the respective entities (e.g. TRP and user device) pertain.

If there may be multiple (e.g. at least two) communication paths between a respective user device and base station (e.g. gNB), additional means for disambiguation, e.g. chosen by the respective base station and being unique within the respective base station, or, if there is at most a single communication path per cell (as it is the case of current communication standards), by the NG Cell Global Identity (NCGI) (e.g. 3GPP TS 23.003), may be used.

According to an exemplary embodiment of all exemplary aspects, the communication report further comprises at least one of a radio link identifier of the respective radio link, or a cell identifier of a cell handling the respective radio link.

For characterizing (e.g. future) blockage of a respective radio link, and to be enabled to perform and/or control at least one measure in order to optimally prevent a RLF, the respective apparatus of the second exemplary aspect handling the communication to and from the apparatus of the third exemplary aspect (e.g. user device) may benefit from knowing the respective identifier of the radio link, or at least a respective cell identifier of a cell handling the respective radio link so that the respective radio link may be determined (e.g. derived) based, at least in part, on the cell identifier and the knowledge of the entities of the respective radio link. Further, for proactive blockage mitigation, it may be beneficial if in addition to the respective radio link identifier that is blocked or may (e.g. with a certain likelihood) be subject to a blockage, a (e.g. predicted) time (starting time) when the respective blockage occurs or will start to occur is comprised by the respective blockage information. The respective apparatus of the second exemplary aspect (e.g. base station) may infer the communication path from the user device (e.g. apparatus of the third exemplary aspect)-specific signaling connection, e.g. over which the blockage information (e.g. comprised by or represented by a blockage notification message) has been received, or, in case the respective base station has previously included a radio link identifier in its communication report (e.g. message), via the link identifier that may be comprised by the communication report.

According to an exemplary embodiment of the first exemplary aspect, the communication report is received from the base station, or the communication report is divided into a first communication report received from the base station and a second communication report received from the user device.

In this case the communication report may be divided into a first communication report received from the base station (e.g. apparatus of the second exemplary aspect) and a second communication report received from the user device (e.g. apparatus of the third exemplary aspect). The communication report received from the base station may comprise information (e.g. only) relating to the respective radio link from the perspective of the base station (e.g. AoA of a respective radio link), The communication report received from the user device may comprise information (e.g. only) relating to the respective radio link from the perspective of the user device (e.g. AoD of the respective radio link), to name but one non-limiting example.

Further, as a part of the (e.g. continuous) sensing operation that may be performed and/or controlled (e.g. by the apparatus providing the communication report so that the apparatus of the first exemplary aspect can receive the communication report) e.g. within a coverage area of the mobile communication network, sensing-enabled base station(s) and/or user device(s) may report sensed objects to the apparatus of the first exemplary aspect (e.g. a respective SMF) according to their respective sensing configuration (e.g. which may be managed by the respective apparatus of the first exemplary aspect, e.g. SMF). Thus, whenever e.g. a respective base station has switched a serving beam pair for a respective user device, the respective SMF may be updated with the new AoA and AoD via respective communication report message(s), as disclosed above.

According to an exemplary embodiment of all exemplary aspects, a communication report is transmitted by the respective UE and/or the respective base station (e.g. gNB) after AoA/AoD has changed.

According to an exemplary embodiment of the first exemplary aspect, the blockage information is determined based on one or more further communication reports relating to one or more radio links of other respective user devices present in a cell of the respective radio link.

For instance, a potential (and e.g. already identified) blockage occurring to a respective radio link, may be utilized to check if the respective blockage might also occur to the respective radio link respectively further radio links of at least one other user device (may also be an apparatus of the third exemplary aspect). Thus, the apparatus of the first exemplary aspect may aggregate such information based e.g. on multiple (e.g. at least two) communication reports the apparatus of the first exemplary aspect may have received from different entities.

According to an exemplary embodiment of all exemplary aspects, the blockage information comprises one or more of the following information:
location of the blockage;
dimensions of the blockage;
velocity of the blockage, e.g. including a direction, for instance represented by a vector; angular range of the blockage with respect to the angle-of-arrival and/or the angle-of-departure, e.g. as seen from a respective base station and/or a respective user device; duration of the blockage; and
signal attenuation due to the blockage.

One or more of the above mentioned information that may be comprised by the blockage information may be (e.g. each) comprised with a determined uncertainty of estimation/prediction, e.g. at least as an integer value between 0 and 1, to name but one non-limiting example.

Optionally, a respective blockage information (e.g. blocker notification message) may comprise or include information, in the following also referred to as beam selection assistance information (BSAI), to further aid a determining of at least one measure (e.g. as determined by the apparatus of the second exemplary aspect), such as a new radio link, or e.g. a selection of a radio link that may not be subject to a blockage soon, to name but a few non-limiting examples.

As briefly mentioned above, corresponding to the method that may be performed and/or controlled by the apparatus of the first exemplary aspect, the apparatus of the second exemplary aspect can transmit the respective communication report indicative of information relating to at least one radio link between the apparatus of the second exemplary aspect and a user device (e.g. apparatus of the third exemplary aspect). In response to the transmitted communication report, for instance, the apparatus of the second exemplary aspect may receive the blockage information, if it is determined by the apparatus of the first exemplary aspect that a blockage occurs or is likely to occur to a respective radio link handled by the apparatus of the second exemplary aspect. In the alternative, thus, in case the apparatus of the second exemplary does not receive such a blockage information, the apparatus of the second exemplary aspect can determine the blockage information by itself. In this case, the blockage information can be determined based, at least in part, on the communication report that the apparatus of the second exemplary has transmitted (e.g. since the communication report may comprise e.g. AoA/AoD of the respective radio link) and a position of the apparatus of the second exemplary aspect and a position of the user device (e.g. apparatus of the third exemplary aspect). The determined blockage information is indicative of the respective radio link and a time when a blockage of the respective radio link occurs, or when the blockage is determined to occur with a certain likelihood, as disclosed above regarding the first exemplary aspect.

The apparatus of the second exemplary aspect further determines at least one measure. Such a respective at least one measure may for instance be a possible beam switch to be utilized by the radio link so that the radio link is emitted and received from different AoA/AoD. Further, at least one measure may be a possible handover to be performed, e.g. to mitigate the blockage of the respective radio link as represented by the received or determined blockage information. Then, the apparatus of the second exemplary aspect applies the determined at least one measure.

According to an exemplary embodiment of the second exemplary aspect, the method further comprises:
receiving, from the user device, at least one of the angle-of-arrival or the angle-of-departure relating to the respective radio link (e.g. via PHY or MAC signaling); and
aggregating the received at least one of the angle-of-arrival or the angle-of-departure relating to the respective radio link into the communication report, wherein the communication report is aggregated so that the communication report further comprises at least one of the angle-of-arrival or the angle-of-departure used by the apparatus and an identifier of the respective radio link.

In a first variant, e.g. AoA may be received from the respective user device (e.g. apparatus of the third exemplary aspect), e.g. as a part of PHY or MAC signaling, by the apparatus of the second exemplary aspect. This may be enabled e.g. due to prior RRC configuration, e.g. performed and/or controlled by the apparatus of the second exemplary aspect. The apparatus of the second exemplary aspect may further aggregate e.g. the received AoA with its AoD and a radio link identifier (ID) into a single communication report (e.g. comprised by a respective message) and transmit the respective communication report to the apparatus of the first exemplary aspect (e.g. a respective SMF).

According to an exemplary embodiment of all exemplary aspects, the communication report comprises multiple sets (e.g. at least two) of information relating to multiple radio links.

The respective communication report may comprise or include multiple (e.g. at least two) sets of AoA, AoD (e.g. as a beam pair) and a respective radio link ID. One of such sets may thus be related to one (e.g. switched) beam pair handled by the apparatus of the second exemplary aspect. The actual information as comprised by the communication report or within the communication report may differ, e.g. information that may not have changed may be omitted, and/or AoA/AOD may be differentially encoded so that AoA/AOD value(s) represent a difference of a value to a respective last communication report transmitted by the apparatus of the second exemplary aspect, or a respective radio link ID may be omitted if there is (e.g. only) a single communication path between the apparatus of the second exemplary aspect and the respective user device, to name but a few variations that the apparatus of the second exemplary aspect is enabled to perform and/or control when transmitting the communication report, be it a very first transmitting of the communication report or a repeated transmitting intended to e.g. perform and/or control a status update of one or more respective radio links handled by the apparatus of the second exemplary aspect.

In a second variant, the user device may directly transmit (e.g. sent) a communication report, e.g. as a NAS message (e.g. via N1 interface). This may be a first communication report of the communication report that may be splitted, as disclosed above. The apparatus of the second exemplary aspect may then in its communication report (e.g. via N2 interface) include its own AoD. In case there may exist multiple active/serving communication paths between the apparatus of the second exemplary aspect and the user device, such respective (e.g. both) communication reports may include or comprise NCGI of the cell (e.g. and thereby TRP) where beam switch may have been occurred for disambiguation.

It will be understood that the apparatus of the second exemplary aspect may (e.g. only) receive a respective blockage information if and/or when the apparatus of the first exemplary aspect has determined a respective blockage information and provides the blockage information to the apparatus of the second exemplary aspect. Thus, if a respective blockage information is not received, the respective step of determining the at least one measure and the step of applying the at least one measure may not be performed by the apparatus of the second exemplary aspect. In the alternative, if a respective blockage information is received and the received blockage information is not indicative of a respective blockage that may occur regarding the respective radio link, also the respective step of determining the at least one measure and the step of applying the at least one measure may not be performed by the apparatus of the second exemplary aspect.

The apparatus of the second exemplary aspect may be a sensing-capable base station. Such a sensing-capable base station (e.g. gNB) may rely on its own sensing e.g. for detecting possible one or more blockages. For instance, in conjunction with the respective position/location of the user device (e.g. as provided via existing standardized positioning, such as via the LMF of the mobile communication network), and the AoA of as seen from the user device, the apparatus of the second exemplary aspect may transmit (e.g. provide) via a PHY or MAC signaling, as disclosed above.

According to an exemplary embodiment of the second exemplary aspect, in case at least one of the angle-of-arrival or the angle-of-departure (e.g. values) relating to the respective radio link is not received from the user device (e.g. before the transmitting of the communication report), the communication report further comprises a cell identifier of a cell handling the respective radio link. Such a respective communication report may be transmitted directly to the apparatus of the first exemplary aspect (e.g. SMF).

The apparatus of the third exemplary aspect (e.g. a respective user device) transmits (e.g. to the apparatus of the first exemplary aspect (e.g. a respective SMF) and/or to the apparatus of the second exemplary aspect (e.g. a respective base station)) a/the respective communication report that may be then received by the apparatus of the first exemplary aspect and/or the apparatus of the second exemplary aspect. At least a part of the communication report is indicative of at least one of an angle-of-arrival of the respective radio link or an angle-of-departure of the respective radio link.

Based on the transmitted (e.g. provided) communication report, the apparatus of the third exemplary aspect may be triggered to perform and/or control at least one measure. The at least one measure may be the at least one measure provided by the apparatus of the second exemplary aspect. The apparatus of the third exemplary aspect can thus apply the at least one measure if needed to mitigate a blockage of the respective radio link. The apparatus of the third exemplary aspect may apply the at least one measure, e.g. to perform and/or control a beam switch for the respective radio link, or participate in a hand over of the respective radio link to a different cell or be handed over to a different cell, to name but a few non-limiting examples.

According to an exemplary embodiment of the third exemplary aspect, in case at least one of the angle- of-arrival or the angle-of-departure relating to the respective radio link is not transmitted to a base station, the communication report comprises a cell identifier of a cell handling the respective radio link. In this case, the respective communication report may be transmitted directly to the apparatus of the first exemplary aspect.

It is to be understood that the presentation in this section is merely by way of examples and non- limiting.

The features and example embodiments described above may equally pertain to the different aspects.

Other features will become apparent from the following detailed description considered in conjunction with the accompanying drawings. It is to be understood, however, that the drawings are designed solely for purposes of illustration and not as a definition of the limits, for which reference should be made to the appended claims. It should be further understood that the drawings are not drawn to scale and that they are merely intended to conceptually illustrate the structures and procedures described herein.

### BRIEF DESCRIPTION OF THE DRAWINGS

In the figures show:

FIG. 1 a schematic block diagram of a system according to an exemplary aspect;

FIG. 2 a flowchart showing an example embodiment of a method according to the first exemplary aspect;

FIG. 3 a flowchart showing an example embodiment of a method according to the second exemplary aspect;

FIG. 4 a flowchart showing an example embodiment of a method according to the third exemplary aspect;

FIG. 5 a schematic block diagram of a system according to an exemplary aspect;

FIG. 6 a signaling flowchart of an example embodiment according to all exemplary aspects;

FIG. 7 another signaling flowchart of an example embodiment according to the second and third exemplary aspects; and

FIG. 8 a schematic block diagram of an apparatus configured to perform the method according to the first, second or third exemplary aspect.

### DETAILED DESCRIPTION OF SOME EXEMPLARY EMBODIMENTS

The following description serves to deepen the understanding and shall be understood to complement and be read together with the description as provided in the above summary section of this specification.

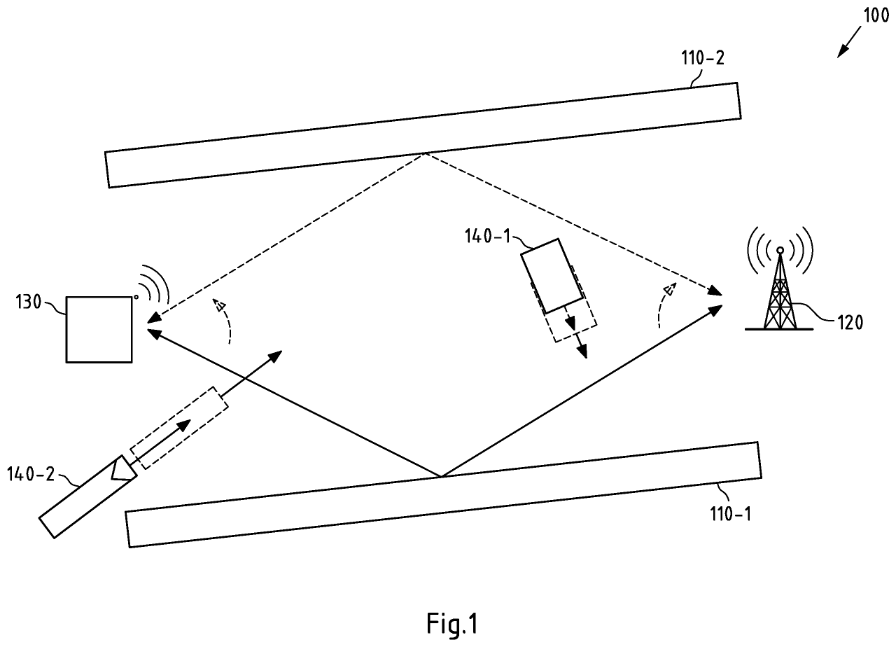

FIG. 1 is a schematic high-level block diagram showing a system 100 according to an exemplary aspect.

System 100 comprises a user device 130 (e.g. apparatus of the third exemplary aspect) and a base station 120 that here provides a TRP (e.g. apparatus of the second exemplary aspect). The user device 130 and the base station 120 may communicate with each other via a mobile communication network (not shown). Part of such a mobile communication network may be a SMF (e.g. apparatus of the first exemplary aspect, not shown in FIG. 1, see FIG. 5 in which it is illustrated). As is shown in FIG. 1, there are two potential blockages 140-1 and 140-2 preventing a LoS radio link between the user device 130 and the base station 120. Blockage 140-1 is currently in between a radio link established between the user device 130 and the base station 120, blocking LoS, such that radio link established between user device 130 and base station 120 is nLoS. Blockage 140-2 is not in between the radio link shown by the dashed and solid arrows pointing to the user device 130 and the base station 120. As is indicated by the arrows at the blockages 140-1 and 140-2, a respective blockage may move in a certain direction or rotate, or a combination thereof. For instance, blockage 140-1 moves in the direction of the radio link illustrated with the solid line that represents the current radio link. Blockage 140-2 may move in between this radio link of the solid line and thus, at least one measure may be performed to mitigate a blockage of the radio link from occurring. Such at least one measure may be a switch of a beam pattern so that the radio link may then be represented by the double arrow representing the dashed line between the user device 130 and the base station 120. This measure is illustrated by the rounded and dashed arrow pointing from the solid double arrow of the radio link to the dashed double arrow, wherein the rounded and dashed arrow is illustrated at the radio link at both the user device 130 and the base station 120. Further, blockage 140-2 may also move in between the radio link between the user device 130 and the base station 120. Reflections (e.g. walls or objects) 110-1 and 110-2 may reflect the radio link so that the communication via the radio link of the user device 130 and the base station 120 is established as a nLoS communication.

For instance, for enabling that the above described switch can occur, example embodiments according to all exemplary aspect enable that e.g. a SMF of the mobile communication network receives a communication report from the user device 130 and/or from the base station 120, wherein the communication report is indicative of information relating to at least one radio link between the base station 120 of the mobile communication network and the user device 130, wherein at least a part of the communication report is indicative of an angle-of-arrival of the respective radio link and an angle-of-departure of the respective radio link, as shown by the double arrows pointing from and to a certain angle away and to the user device 130 and the base station 120. Based on the received communication report(s), a blockage information is determined. The communication report is determined further based on a position of the base station 120 and a position of the user device 130, wherein the blockage information is indicative of the respective radio link and a time when a blockage of the respective radio link occurs. Then, to mitigate a potential blockage, the determined blockage information is provided, e.g. to the base station 120. The base station 120 determines at least one measure, here the switching of the beam pattern used for the respective radio link.

For instance, when targeting Ultra Reliable Low Latency Communications (URLLC) in wireless networks in FR2 bands, interruption of communication must be mitigated. Such interruption may be due to sudden obstructions by one or more (e.g. large) objects, such as blockages 140-1 and 140-2. One solution may be to use dual/multi-connectivity and rely on a fully-maintained secondary link to fall back to during blockage/failure of the primary link until beam search/refinement/update procedures reestablished the primary link. The second link could be a lower frequency carrier in FR1 from the same TRP or another FR2 carrier from a second TRP. This obviously has drawbacks, such as increased power consumption and blocking of resources available on part of the mobile communication network. Example embodiments of all exemplary aspect may enable to proactively switch beams or handover to another TRP before the obstruction occurs as at least one measure.

Sensing-capable mobile communication networks (e.g. 6G), in particular a central entity (e.g. apparatus of the first exemplary aspect, such as a sensing management function (SMF)) may collect (e.g. all) sensing information and may derive thereof a digital twin of the environment the mobile communication network it is located in. What sensing does not provide, though, are the communication paths between TRPs (e.g. hosted by a respective base station 120) and/or a base station (e.g. base station 120) and user devices (e.g. user device 130) of the mobile communication network. Further, when such a SMF determines that a communication path within the digital twin will likely be blocked soon, the SMF may be equipped with the ability to influence the communication path(s) to mitigate the predicted blockage. Determining positions and movements of objects via sensing may be straight forward, however, it is relatively challenging to determine the effective attenuation an object might cause to the signal when it intersects a communication path. However, effective attenuation may not be needed in the example embodiments of all exemplary aspects.

Further, e.g. in 5G mobile communication networks, the respective location management function (LMF) maintains locations of such TRPs and user devices e.g. by means of active positioning schemes (like TDOA). The SMF maintains locations of passive (non-communicating) objects by means of sensing. LMF and SMF may be integrated or may be separate entities. If LMF and SMF are separate, means for the SMF to acquire (e.g. all) TRP and user device locations may be beneficial for the purpose of determining (e.g. all) communication paths. This can be provided to the SMF either by the LMF, e.g. by defining a respective interface and protocol between LMF and SMF, or by base stations, e.g. by extending a communication report message (e.g. the communication report of all exemplary aspects) with one or more positions of TRP and user device.

Such example embodiments may have the advantage of minimal impact on standardization, as (e.g. only) PHY or MAC signaling for conveying the user device's AoA need to be standardized, but may not have the benefit of blockage prediction, as (e.g. only) those passive objects that can be used by the gNB itself and (e.g. only) those objects with a free LoS path between the blockage/object and (one of the) base station's TRP(s) are taken into account

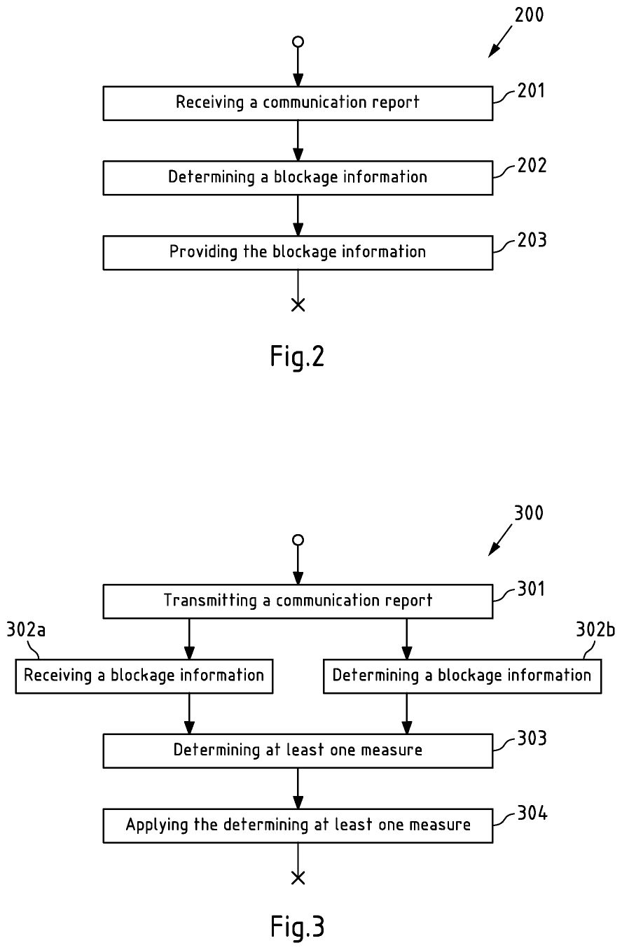

FIG. 2 is a flowchart 200 showing an example embodiment of a method according to the first exemplary aspect. This flowchart 200 may for instance be performed by a SMF of a mobile communication network.

In a first step 201, a communication report is received. The communication report is indicative of information relating to at least one radio link between a base station (e.g. base station 120 of FIG. 1) of the mobile communication network and a user device (e.g. user device 130 of FIG. 1), wherein at least a part of the communication report is indicative of an angle-of-arrival of the respective radio link and an angle-of-departure of the respective radio link. The communication report may be obtained (e.g. received) from the base station and/or the user device.

In a second step 202, a blockage information is determined. The blockage information is determined based, at least in part, on the communication report, and a position of the base station and a position of the user device, wherein the blockage information is indicative of the respective radio link and a time when a blockage of the respective radio link occurs.

In a third step, the determined blockage information is provided, e.g. by sending the determined blockage information e.g. to the base station.

FIG. 3 is a flowchart 300 showing an example embodiment of a method according to the second exemplary aspect. This flowchart 300 may for instance be performed by a base station (e.g. base station 120 of FIG. 1) of a mobile communication network.

In a first step 301, a communication report is transmitted, e.g. to a SMF (e.g. apparatus of the first exemplary aspect). In addition or in the alternative, such a communication report may be received from a user device (e.g. user device 130 of FIG. 1), e.g. via MAC/PHY signalling. The communication report is indicative of information relating to at least one radio link between the apparatus performing the flowchart 300 and a user device (e.g. user device 130 of FIG. 1), wherein at least a part of the communication report is indicative of at least one of an angle-of-arrival of the respective radio link or an angle-of-departure of the respective radio link.

In a second step302a, a blockage information is received. The blockage information may be received from a respective SMF. In addition or in the alternative to step 302a, for instance in case a blockage information is not received (e.g. from the SMF), in a step 302b, the apparatus performing and/or controlling the flowchart 300 can determine a respective blockage information. For this, optionally, a respective communication report may be received from the user device.

The blockage information is determined based, at least in part, on the communication report that is also transmitted in step 301, and a position of the base station and a position of the user device.

In a third step 303, at least one measure to mitigate the blockage of the respective radio link is determined. The at least one measure is determined based, at least in part, on the received blockage information (see step 302a), or based, at least in part, on the determined blockage information (see step 302b). In addition or in the alternative, the blockage information may be received, but the base station may determine (e.g. decide) not to mitigate the predicted blockage, e.g. because no more data is to transmit to the user device and/or the user device may be is (or was just) put in RRC_INACTIVE state, and/or unavailability of alternatives, and/or accepting risk of blockage when blockage information indicated high uncertainty (e.g. and the user device's Quality of Service requirements may allow for a certain failure probability), to name but a few non-limiting examples.

In a fourth step 304, the determined at least one measure is applied, e.g. a respective beam is switched or the respective radio link is handed over to another cell, to name but a few non-limiting examples.

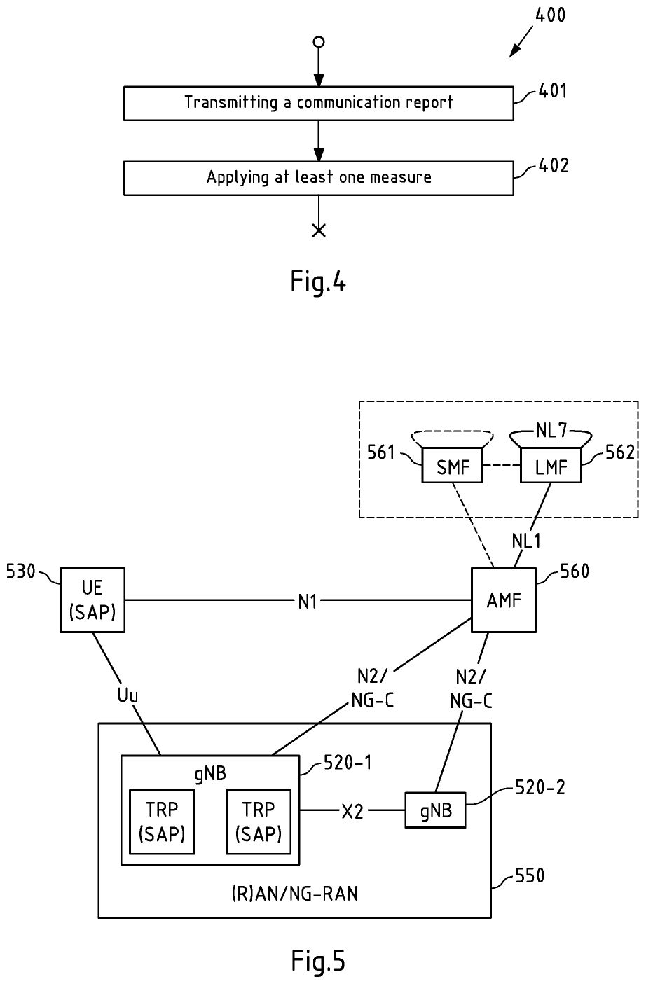

FIG. 4 is a flowchart 400 showing an example embodiment of a method according to the third exemplary aspect. This flowchart 400 may for instance be performed by a user device (e.g. user device 130 of FIG. 1) of a mobile communication network.

In a first step 401, a communication report is transmitted. The communication report may be transmitted to a base station (e.g. base station 120 of FIG. 1), and/or to a SMF of the mobile communication network (not shown in FIG. 1). At least a part of the communication report is indicative of at least one of an angle-of-arrival of the respective radio link or an angle-of-departure of the respective radio link and a cell identifier of a cell handling a respective radio link between the apparatus performing and/or controlling the flowchart 400 and the base station. The communication report may be transmitted via PHY and/or MAC signaling.

In a second step 402, at least one measure is applied. The at least one measure is applied to mitigate a blockage of the respective radio link. For this, the apparatus performing and/or controlling the flowchart 400 may receive instructions (e.g. via PHY or MAC or RRC signaling) that may trigger the applying of the at least one measure.

FIG. 5 depicts one or more parts of a current 3GPP 5G system (5GS) architecture, that is amended with sensing-related entities sensing access points (SAP) and a respective SMF (not the session Management Function of the overall 5Gs architecture, e.g. as comprised by 3GPP TS 23.501, but e.g. an apparatus of the first exemplary aspect), as utilizable by example embodiments of all exemplary aspects.

The system 500 of FIG. 5 may enable example embodiments of all exemplary aspects. System 500 comprises a user device 530 (e.g. apparatus of the third exemplary aspect), a Radio Access Network (RAN) 550, an AMF 560 having connection to a SMF 561 (e.g. apparatus of the first exemplary aspect) and a LMF 562. The RAN 550 is a NG (Next Generation) RAN, wherein exemplary two base stations (e.g. apparatus(es) of the second exemplary aspect) are comprised: gNB 520-1 and gNB 520-2. gNB 520-1 hosts two TRPs as SAPs. The line connecting the different entities/parts illustrated in FIG. 5 has a respective interface reference sign at the respective illustrated line, highlighting in an exemplary manner which respective interface may be used for a communication of the entities connected via a respective line. For instance, gNB 520-1 and gNB 520-2 may communicate via an Xn interface. Each of the gNB 520-1 and gNB 520-2 may communicate with the AMF 560 via a N2/NG-C interface. UE 530 may communicate with gNB 520-1 hosting e.g. a respective cell in which UE 530 is located via a uU-interface, and further, may communicate with the AMF 560 via a N1-interface. The AMF 560 may communicate with the LMF 562 via a NL1-interface, wherein the LMF 562 may also have access to a NL7 interface. The same may apply to the SMF 561, in particular if the LMF 562 and the SMF 561 are integrated as a single entity. Further, if SMF and LMF are not integrated, respective equivalents of interfaces NL1 and NL7 are assumed to be defined for AMF-SMF and SMF-SMF communication, respectively.

Sensing-capable user devices (‘UE’, e.g. apparatus(es) of the third exemplary aspect) and base stations (‘gNB’, e.g. apparatus(es) of the second exemplary aspect) act as SAPs, e.g. they communicate with the SMF to report their sensing measurements according to prior configurations and sensing requests by the SMF. Whether the SMF is a separate entity with own interfaces to the LMF and the Access and Mobility Management Function (AMF) or integrated with the LMF makes no difference with respect to example embodiments of all exemplary aspects (e.g. only) the interface respectively application layer protocol that carriers such message(s) may slightly differ.

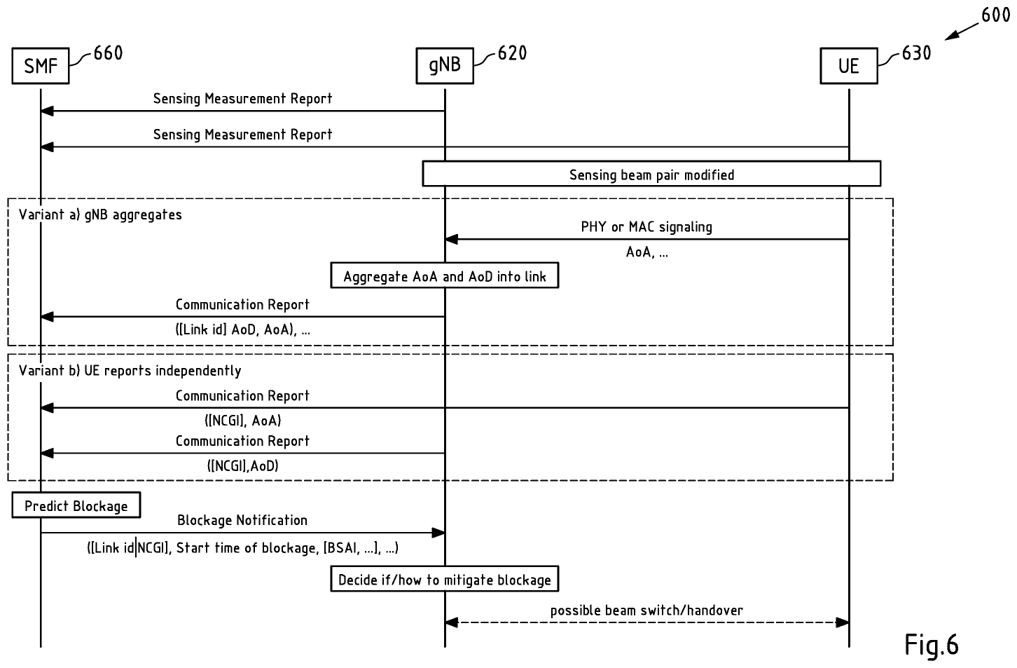

FIG. 6 illustrates a signaling flowchart of an example embodiment according to all exemplary aspects. FIG. 6 shows the interaction of three entities as comprised by a system 600 of all exemplary aspects. System 600 comprises a SMF 660 (e.g. apparatus of the first exemplary aspect), a gNB 620 (e.g. apparatus of the second exemplary aspect) and a UE 630 (e.g. apparatus of the third exemplary aspect).

Both the UE 630 and the gNB 620 provide a sensing measurement report to the SMG 660. As part of the (e.g. continuous) sensing operation within the coverage area of the RAN, sensing-enabled gNBs and UEs report sensed objects to the SMF according to their respective sensing configuration (e.g. managed by the SMF). Whenever the gNB has switched the serving beam pair for a UE, the SMF is updated with the new AoA and AoD via communication report messages.

Thus and for instance, if a sensing beam pair utilized for a respective radio link between the gNB 620 and the UE 630 is modified, in a variant a), a respective communication report is transmitted from the gNB 620 to the SMF 660. To be enabled to transmit the communication report to the SMF 660, the gNB 630 may receive another communication report indicative of the AoA of the respective radio link from the UE 630. This communication report may be provided by the UE 630 to the gNB 620 via PHY or MAC signaling. In advance, the gNB 620 may have configured the UE 630 to do so, e.g. via RRC signaling to name but one non-limiting example. The communication report transmitted by the gNB 620 to the SMF 660 may have been a result of an aggregation performed and/or controlled by the gNB 630, wherein the gNB 630 aggregates the AoA as received from the UE 630 with its known AoD of the respective radio link and the respective radio link ID and comprises this in the communication report that is then transmitted from the gNB 630 to the SMF 660.

Thus, AoA from the UE 630 can be reported as part of PHY or MAC signaling to the gNB 620, e.g. according to prior RRC configuration (not shown) by the gNB 620. The gNB 620 can then aggregate AoA with its AoD and a link ID into a single communication report message to the SMF 660. The communication report may include multiple sets of (link id, AoD, AoA), one set per each switched beam pair. Actual information within the communication report may differ, e.g. information not changed may be omitted, and/or angles may be differentially encoded as a difference to the last communication report, or the link ID may be omitted if there is only a single communication path between gNB 620 und UE 630.

In a variant b) that may be performed and/or controlled by the system 600 in addition or in the alternative to the variant a), the gNB 630 may not aggregate AoA, AoD and the respective radio link ID into the communication report, but the communication report received by the SMF 660 is split into a first communication report, here transmitted from the UE 630 to the SMF 660, and a second communication report transmitted from the gNB 630 to the SMF 660. The communication report of the UE 630 comprises a cell identifier, here NCGI and the AoA of the respective radio link, and correspondingly, the communication report provided by the gNB 620 comprises also the cell identifier, here NCGI and the AoD of the respective radio link, so that the SMF 660 is enabled to merge the two communication reports.

Thus, in the variant b), the UE 630 directly sends a respective communication report message e.g. as a NAS message (e.g. via N1 interface), and the gNB 630 in its communication report (e.g. via N2 interface) (e.g. only) includes its own AoD. In case there exist multiple active/serving communication paths between gNB 620 and UE 630, both respective communication reports include the NCGI of their respective cell (and thereby TRP) where beam switch occurred for disambiguation.

Based on the received communication reports, the SMF 660 determines a respective blockage information ('predict blockage') and provides the determined blockage information (e.g. as a respective blockage notification) comprising e.g. the radio link identifier, the cell identifier NCGI, a respective start time of the blockage, one or more parameters as a respective beam selection assistance information (BSAI), or a combination thereof, e.g. to the gNB 620.

Optionally, a respective blocker notification message may include information called BSAI to further aid a respective selection of a proper new communication link, e.g. selection of a link that won't be soon blocked, too.

Examples for such optional BSAI may be:
location of the blocker and its dimensions (e.g. as a bounding box/cuboid, or more generally as a polyhedron),
velocity of the blocker (incl. direction, e.g. as a vector),
angular range of blocked AoA and/or AoD (as seen from gNB and/or UE),
duration of blockage,
signal attenuation,

(e.g. each) possibly with the uncertainty of estimation/prediction.

The gNB 620 determines, based at least in part, on the received blockage information at least one measure, e.g. by deciding if and/or how to mitigate the respective blockage as indicated in the blockage information. Then, finally, the at least one measure can be applied by the gNB 620 and the UE 630 (see ‘possible beam switch/handover’) in FIG. 6.

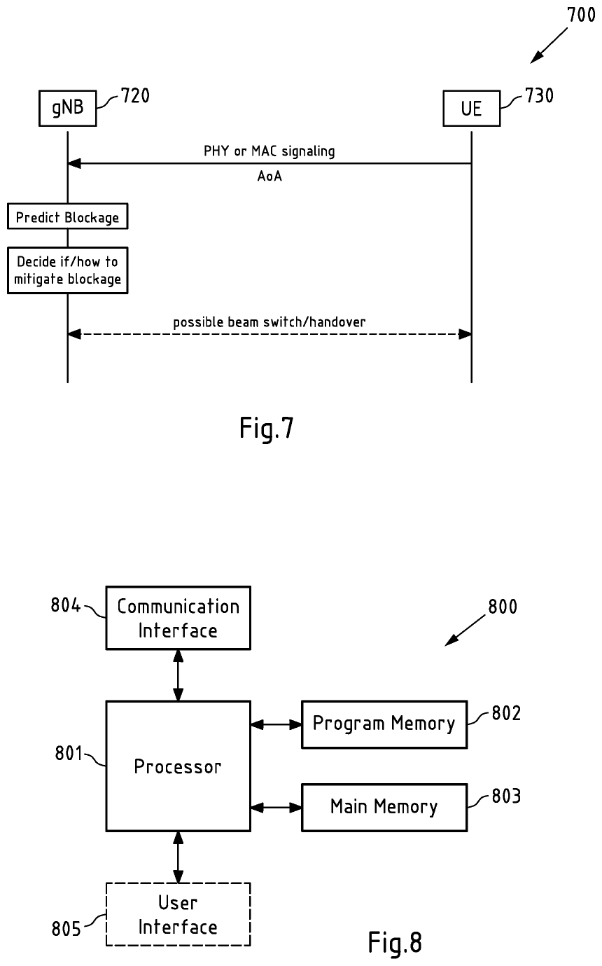

FIG. 7 shows another signaling flowchart of an example embodiment according to all exemplary aspects.

FIG. 7 shows the interaction of two entities as comprised by a system 700 of all exemplary aspects. System 700 comprises a gNB 720 (e.g. apparatus of the second exemplary aspect) and a UE 730 (e.g. apparatus of the third exemplary aspect). In this example embodiment, the gNB 720 is enabled to perform and/or control one or more functions that may also be performed and/or controlled by a respective SMF (e.g. apparatus of the first exemplary aspect) of a respective mobile communication network.

In system 700, a sensing-capable gNB 720 may rely (e.g. only) on its own sensing for detecting possible blockages/blockers, e.g. in conjunction with the position/location of the UE 730. The position of the UE 730 may be provided via standardized positioning (e.g. via a respective LMF, see LMF 562 of FIG. 5) and the UE's 730 AoA that the UE 730 may provides e.g. via PHY or MAC signaling as described regarding FIG. 6.

Compared to the system 600 of FIG. 6, system 700 may have reduced or minimal impact on standardization, as (e.g. only) PHY or MAC signaling for conveying the UE's 730 AoA is to be standardized. However, the blockage information may be inferior compared to the system 600 of FIG. 6, as (e.g. only) those passive blockages/objects that can be sensed by the gNB 720 itself are taken into account, i.e. (e.g. only) those objects with a free LoS path between the blockage/object and (e.g. one of the) gNB's 720 TRP(s).

FIG. 8 is a schematic block diagram of an apparatus 800 according to the first or second or third exemplary aspect. Apparatus 800 may for instance represent a respective central entity, such as a SMF (see e.g. SMF 660 of FIG. 6), a respective user device (see UE 630 of FIG. 6), or a respective base station (see gNB 620 of FIG. 6), to name but a few non-limiting examples. Equal entities as disclosed in conjunction e.g. with FIGS. 1 to 7 may also be represented by the apparatus 800.

Apparatus 800 comprises a processor 801, a program memory 802, a main memory 803, communication interface(s) 804, and a user interface 805. In various embodiments, the apparatus 800 comprises further units, parts or structural and/or functional elements. In various embodiments, apparatus 800 is a user equipment, e.g., for a cellular network like 5G NR.

Apparatus 800 may for instance be configured to perform and/or control or comprise respective means (at least one of 801 to 805) for performing and/or controlling and/or configured to perform the method according to the first or second or third exemplary aspect. Apparatus 800 may as well constitute an apparatus comprising at least one processor 801 and at least one memory 802 including computer program code, the at least one memory 802 and the computer program code configured to, with the at least one processor 801, cause an apparatus, e.g. apparatus 800 at least to perform and/or control the method according to the first or second or third exemplary aspect.

Processor 801 may for instance further control the memories 802 to 803, and/or the communication interface(s) 904.

Processor 801 may for instance execute computer program code stored in program memory 802, which may for instance represent a computer readable storage medium comprising program code that, when executed by processor 801, causes the processor 801 to perform the method according to the first or second or third exemplary aspect.

Processor 801 (and also any other processor mentioned in this specification) may be a processor of any suitable type. Processor 801 may comprise but is not limited to one or more microprocessor(s), one or more processor(s) with accompanying one or more digital signal processor(s), one or more processor(s) without accompanying digital signal processor(s), one or more special-purpose computer chips, one or more field-programmable gate array(s) (FPGA(s)), one or more controller(s), one or more application-specific integrated circuit(s) (ASIC(s)), or one or more computer(s). The relevant structure/hardware has been programmed in such a way to carry out the described function. Processor 801 may for instance be an application processor that runs an operating system.

Program memory 802 may also be included into processor 801. This memory may for instance be fixedly connected to processor 801, or be at least partially removable from processor 801, for instance in the form of a memory card or stick. Program memory 802 may for instance be non-volatile memory. It may for instance be a FLASH memory (or a part thereof), any of a ROM, PROM, EPROM and EEPROM memory (or a part thereof) or a hard disc (or a part thereof), to name but a few examples. Program memory 802 may also comprise an operating system for processor 801. Program memory 802 may also comprise a firmware for apparatus 800.

Apparatus 800 may comprise a working or main memory 803, for instance in the form of a volatile memory. It may for instance be a Random Access Memory (RAM) or Dynamic RAM (DRAM), to give but a few non-limiting examples. It may for instance be used by processor 801 when executing an operating system and/or computer program.

Data memory (not shown) may for instance be a non-volatile memory. It may for instance be a FLASH memory (or a part thereof), any of a ROM, PROM, EPROM and EEPROM memory (or a part thereof) or a hard disc (or a part thereof), to name but a few examples.

Communication interface(s) 804 enable apparatus 800 to communicate with other entities, e.g. with one or more of the apparatuses120, and/or 130 of FIG. 1 and/or one or more of the apparatus 530, 550, 560 of FIG. 5, and/or one or more of the apparatus 620, 630, 660 of FIG. 6, and/or one or more of the apparatus 720, or 730 of FIG. 7 and/or further network devices, e.g. of the same network, e.g. mobile communication network. The communication interface(s) 804 may for instance comprise a wireless interface, e.g. a cellular radio communication interface and/or a WLAN interface) and/or wire-bound interface, e.g. an IP-based interface, for instance to communicate with entities via the Internet or a network backbone, e.g. a 5G NR, or 6G backbone, to name but a few non-limiting example.

Sensor(s) (not shown) are optional and may for instance comprise a gyroscope, global positioning system sensor or a received signal strength sensor.

User interface 805 is optional and may comprise a display for displaying information to a user and/or an input device (e.g. a keyboard, keypad, touchpad, mouse, etc.) for receiving information from a user.

Some or all of the components of the apparatus 800 may for instance be connected via a bus. Some or all of the components of the apparatus 800 may for instance be combined into one or more modules.

Furthermore, at least the following embodiments should be considered to be specifically disclosed:

### Embodiment 1

A method comprising:
receiving a communication report indicative of information relating to at least one radio link between a base station of a mobile communication network and a user device, wherein at least a part of the communication report is indicative of an angle-of-arrival of the respective radio link and an angle-of-departure of the respective radio link;
determining a blockage information based, at least in part, on the communication report, and a position of the base station and a position of the user device, wherein the blockage information is indicative of the respective radio link and a time when a blockage of the respective radio link occurs; and
providing, if a blockage information is determined, the blockage information.

### Embodiment 2

The method of embodiment 1, wherein the determining of the blockage information further comprises: determining whether the respective radio link is subject to a blockage or not.

### Embodiment 3

The method of embodiment 1 or embodiment 2, wherein the communication report further comprises at least one of a radio link identifier of the respective radio link, or a cell identifier of a cell handling the respective radio link.

### Embodiment 4

The method of any of the embodiments 1 to 3, wherein the communication report is received from the base station, or wherein the communication report is divided into a first communication report received from the base station and a second communication report received from the user device.

### Embodiment 5

The method of any of the preceding embodiments, wherein the blockage information is determined based on one or more further communication reports relating to one or more radio links of other respective user devices present in a cell of the respective radio link.

### Embodiment 6

A method comprising:
transmitting a communication report indicative of information relating to at least one radio link between a base station and a user device, wherein at least a part of the communication report is indicative of at least one of an angle-of-arrival of the respective radio link or an angle-of-departure of the respective radio link;
   receiving a blockage information indicative of the respective radio link and a time when a blockage of the respective radio link occurs; and/or
   in case a blockage information is not received,
   determining a blockage information based, at least in part, on the communication report and a position of the base station and a position of the user device, wherein the blockage information is indicative of the respective radio link and a time when a blockage of the respective radio link occurs; and
determining at least one measure based, at least in part, on the received blockage information, or on the determined blockage information to mitigate the blockage of the respective radio link; and
applying the determined at least one measure.

### Embodiment 7

The method of embodiment 7, further comprising:
receiving (e.g. from the user device) at least one of the angle-of-arrival or the angle-of-departure relating to the respective radio link; and
aggregating the received at least one of the angle-of-arrival or the angle-of-departure relating to the respective radio link into the communication report, wherein the communication report is aggregated so that the communication report further comprises at least one of the angle-of-arrival or the angle-of-departure used (e.g. by the base station or apparatus performing and/or controlling this method) and an identifier of the respective radio link.

### Embodiment 8

The method of embodiment 6 or embodiment 7, wherein, in case at least one of the angle-of-arrival or the angle-of-departure relating to the respective radio link is not received (e.g. from the user device), the communication report further comprises a cell identifier of a cell handling the respective radio link.

### Embodiment 9

A method comprising:
transmitting a communication report indicative of information relating to at least one radio link between a user device and a base station of a mobile communication network, wherein at least a part of the communication report is indicative of at least one of an angle-of-arrival of the respective radio link or an angle-of-departure of the respective radio link; and
applying at least one measure to mitigate a blockage of the respective radio link.

### Embodiment 10

The method of embodiment 9, wherein, in case at least one of the angle-of-arrival or the angle-of-departure relating to the respective radio link is not transmitted (e.g. to a base station), the communication report comprises a cell identifier of a cell handling the respective radio link.

### Embodiment 11

A first apparatus comprising respective means for performing the method of any of embodiments 1 to 5.

### Embodiment 12

A first apparatus comprising at least one processor and at least one memory storing instructions that, when executed by the at least one processor, cause an apparatus at least to perform and/or control the method according any of embodiments 1 to 5.

### Embodiment 13

A second apparatus comprising respective means for performing the method of any of embodiments 6 to 8.

### Embodiment 14

A second apparatus comprising at least one processor and at least one memory storing instructions that, when executed by the at least one processor, cause an apparatus at least to perform and/or control the method according any of embodiments 6 to 8.

### Embodiment 15

A third apparatus comprising respective means for performing the method of any of embodiments 9 to 10.

### Embodiment 16

A third apparatus comprising at least one processor and at least one memory storing instructions that, when executed by the at least one processor, cause an apparatus at least to perform and/or control the method according any of embodiments 9 to 10.

### Embodiment 17

A computer program, the computer program when executed by a processor causing an apparatus, e.g. the apparatus according to any of embodiments 11 to 16, to perform and/or control the actions and/or steps of the method of any of embodiments 1 to 10.

### Embodiment 18

A computer program product comprising a computer program according to embodiment 17.

### Embodiment 20

A system comprising:
at least a first apparatus according to any of embodiments 11 or 12 and at least a second apparatus according to any of embodiments 13 or 14; and at least a third apparatus according to any of embodiments 15 or 16.

### Embodiment 21

A system comprising:
at least a second apparatus according to any of embodiments 13 or 14; and
at least a third apparatus according to any of embodiments 15 or 16.

In the present specification, any presented connection in the described embodiments is to be understood in a way that the involved components are operationally coupled. Thus, the connections can be direct or indirect with any number or combination of intervening elements, and there may be merely a functional relationship between the components.

Moreover, any of the methods, processes and actions described or illustrated herein may be implemented using executable instructions in a general-purpose or special-purpose processor and stored on a computer-readable storage medium (e.g., disk, memory, or the like) to be executed by such a processor. References to a ‘computer-readable storage medium’ should be understood to encompass specialized circuits such as FPGAs, ASICs, signal processing devices, and other devices.

The expression “A and/or B” is considered to comprise any one of the following three scenarios: (i) A, (ii) B, (iii) A and B. Having the same meaning as the expression “A and/or B”, the expression “at least one of A or B” may be used herein. Furthermore, the article “a” is not to be understood as “one”, i.e. use of the expression “an element” does not preclude that also further elements are present. The term “comprising” is to be understood in an open sense, i.e. in a way that an object that “comprises an element A” may also comprise further elements in addition to element A.

It will be understood that all presented embodiments are only exemplary, and that any feature presented for a particular example embodiment may be used with any aspect on its own or in combination with any feature presented for the same or another particular example embodiment and/or in combination with any other feature not mentioned. In particular, the example embodiments presented in this specification shall also be understood to be disclosed in all possible combinations with each other, as far as it is technically reasonable and the example embodiments are not alternatives with respect to each other. It will further be understood that any feature presented for an example embodiment in a particular category (method/apparatus/computer program/system) may also be used in a corresponding manner in an example embodiment of any other category. It should also be understood that presence of a feature in the presented example embodiments shall not necessarily mean that this feature forms an essential feature and cannot be omitted or substituted.

The statement of a feature comprises at least one of the subsequently enumerated features is not mandatory in the way that the feature comprises all subsequently enumerated features, or at least one feature of the plurality of the subsequently enumerated features. Also, a selection of the enumerated features in any combination or a selection of only one of the enumerated features is possible. The specific combination of all subsequently enumerated features may as well be considered. Also, a plurality of only one of the enumerated features may be possible.

The sequence of all method steps presented above is not mandatory, also alternative sequences may be possible. Nevertheless, the specific sequence of method steps exemplarily shown in the figures shall be considered as one possible sequence of method steps for the respective embodiment described by the respective figure.

The subject-matter has been described above by means of example embodiments. It should be noted that there are alternative ways and variations which are obvious to a skilled person in the art and can be implemented without deviating from the scope of the appended claims.

1.-15. (canceled)

16. An apparatus of a mobile communication network, comprising:
means for receiving a communication report indicative of information relating to at least one radio link between a base station of the mobile communication network and a user device, wherein at least a part of the communication report is indicative of an angle-of-arrival of the respective radio link and an angle-of-departure of the respective radio link;
means for determining a blockage information based, at least in part, on the communication report, and a position of the base station and a position of the user device, wherein the blockage information is indicative of the respective radio link and a time when a blockage of the respective radio link occurs; and
means for providing, if a blockage information is determined, the blockage information.

17. The apparatus of claim 16, wherein the means for determining the blockage information further comprise:
means for determining whether the respective radio link is subject to a blockage or not.

18. The apparatus of claim 16, wherein the communication report further comprises at least one of a radio link identifier of the respective radio link, or a cell identifier of a cell handling the respective radio link.

19. The apparatus of claim 16, wherein the communication report is received from the base station, or wherein the communication report is divided into a first communication report received from the base station and a second communication report received from the user device.

20. The apparatus of claim 16, wherein the blockage information is determined based on one or more further communication reports relating to one or more radio links of other respective user devices present in a cell of the respective radio link.

21. An apparatus of a mobile communication network, comprising:
means for transmitting a communication report indicative of information relating to at least one radio link between the apparatus and a user device, wherein at least a part of the communication report is indicative of at least one of an angle-of-arrival of the respective radio link or an angle-of-departure of the respective radio link;
means for receiving a blockage information indicative of the respective radio link and a time when a blockage of the respective radio link occurs; or in case a blockage information is not received,
means for determining a blockage information based, at least in part, on the communication report and a position of the apparatus and a position of the user device, wherein the blockage information is indicative of the respective radio link and a time when a blockage of the respective radio link occurs;
means for determining at least one measure based, at least in part, on the received blockage information, or on the determined blockage information to mitigate the blockage of the respective radio link; and
means for applying the determined at least one measure.

22. The apparatus of claim 21, further comprising:
means for receiving, from the user device, at least one of the angle-of-arrival or the angle-of-departure relating to the respective radio link; and
means for aggregating the received at least one of the angle-of-arrival or the angle-of-departure relating to the respective radio link into the communication report, wherein the communication report is aggregated so that the communication report further comprises at least one of the angle-of-arrival or the angle-of-departure used by the apparatus and an identifier of the respective radio link.

23. The apparatus of claim 21, wherein, in case at least one of the angle-of-arrival or the angle-of-departure relating to the respective radio link is not received from the user device, the communication report further comprises a cell identifier of a cell handling the respective radio link.

24. An apparatus of a mobile communication network, comprising:
means for transmitting a communication report indicative of information relating to at least one radio link between the apparatus and a base station of the mobile communication network, wherein at least a part of the communication report is indicative of at least one of an angle-of-arrival of the respective radio link or an angle-of-departure of the respective radio link; and
means for applying at least one measure to mitigate a blockage of the respective radio link.

25. The apparatus of claim 24, wherein, in case at least one of the angle-of-arrival or the angle-of-departure relating to the respective radio link is not transmitted to a base station, the communication report comprises a cell identifier of a cell handling the respective radio link.
